(19) United States
(12) Patent Application Publication
(10) Pub. No.: US 2023/0415341 A1
(43) Pub. Date: Dec. 28, 2023

(54) NUMERICAL CONTROL DEVICE AND NUMERICAL CONTROL SYSTEM

(71) Applicant: FANUC CORPORATION, Yamanashi (JP)

(72) Inventor: Kazutaka IMANISHI, Yamanashi (JP)

(73) Assignee: FANUC CORPORATION, Yamanashi (JP)

(21) Appl. No.: 18/251,897

(22) PCT Filed: Nov. 8, 2021
(86) PCT No.: PCT/JP2021/041008

§ 371 Date: May 5, 2023

(30) Foreign Application Priority Data
Nov. 13, 2020 (JP) 2020-189849

(51) Int. Cl. B25J 9/16; G05B 19/4155

(52) U.S. Cl. CPC B25J 9/1664; G05B 19/4155; G05B 2219/40269

(57) ABSTRACT

A numerical control device 5 controls the motion of a machine tool 2 and generates a movement command for a robot control device 6 controlling the motion of a robot 3 to move a control point of the robot 3. The numerical control device 5 is provided with: a first movement command generating unit 56 for calculating, on the basis of a numerical control program, a first target motion locus which is a motion locus target for the control point, and generating a first movement command including the first target motion locus; a second movement command generating unit 57 for generating, on the basis of the numerical control program, a second movement command not including the first target motion locus; a movement command generating entity selecting unit 55 for selecting one of the first and the second movement command generating units 56, 57 as a movement command generating entity; and a data transmit/receive unit 59 for transmitting a movement command generated by the movement command generating entity to the robot control device 6.

### TECHNICAL FIELD

The present disclosure relates to a numerical control device and a numerical control system.

### BACKGROUND ART

In recent years, in order to promote automation of a machining site, a numerical control system for controlling the operation of a machine tool for machining a workpiece and the movement of a robot provided in the vicinity of the machine tool in conjunction with each other has been desired (for example, see Patent Document 1).

Generally, a numerical control program for controlling a machine tool and a robot program for controlling a robot have different programming languages. For this reason, in order to interlock the operation of the machine tool and the operation of the robot, it is necessary for the operator to comprehend both the numerical control program and the robot program.

Patent Document 1 shows a numerical control device that controls both a machine tool and a robot by a numerical control program. More specifically, in the numerical control system shown in Patent Document 1, the numerical control device generates a robot command signal in accordance with a numerical control program, while the robot control device generates a robot program in accordance with the robot command signal and generates a robot control signal for controlling the movement of the robot in accordance with the robot program. According to the numerical control system shown in Patent Document 1, a user familiar with the numerical control program can control the robot without being familiar with the robot program.
Patent Document 1: Japanese Patent No. 6647472

### DISCLOSURE OF THE INVENTION

### Problems to be Solved by the Invention

In the conventional numerical control system, when the numerical control device designates the end point position of the tip of the robot, the robot control device performs kinematic conversion in accordance with a robot program so that the tip of the robot moves to the end point position designated by the numerical control device, thereby driving each joint of the robot. At this time, in the conventional numerical control system, it is not possible for the numerical control device to specify the movement trajectory of the tip of the robot.

As long as the work of replacing the workpiece to be machined by the machine tool can be performed by the robot, there is no significant problem even if the movement trajectory cannot be specified by the numerical control device as described above. However, in a case of causing the robot to take charge of processing on a workpiece such as deburring and cutting, it is necessary to designate not only the end point position of the tip of the robot, but also a movement path thereof. Therefore, in the conventional numerical control system, the workpiece may not be machined with sufficient accuracy.

The present disclosure has been made in view of the above problems, and it is an object of the present disclosure to provide a numerical control device and a numerical control system capable of machining a workpiece with high accuracy by using a machine tool and a robot.

### Means for Solving the Problems

An aspect of the present disclosure is directed to A numerical control device that controls operation of a machine tool and generates a movement command for a robot controller that controls operation of a robot to move a control point of the robot based on a numerical control program, the numerical control device including: a first movement command generator that calculates a target movement trajectory, which is a target of a movement trajectory of the control point, and generates a first movement command including the target movement trajectory based on the numerical control program; a second movement command generator that generates a second movement command which does not include the target movement trajectory based on the numerical control program; a selector that selects, as a movement command generation subject, either one of the first movement command generator or the second movement command generator; and a transmitter that transmits a movement command generated by the movement command generation subject to the robot controller.

Another aspect of the present disclosure is directed to a numerical control system including: a numerical control device that controls operation of a machine tool and generates a movement command for moving a control point of a robot; and a robot controller that is communicable with the numerical control device and controls operation of the robot based on a movement command transmitted from the numerical control device, in which the numerical control device includes: a first movement command generator that calculates a target movement trajectory, which is a target of a movement trajectory of the control point, and generates a first movement command including the target movement trajectory based on the numerical control program; a second movement command generator that generates a second movement command which does not include the target movement trajectory based on the numerical control program; a selector that selects, as a movement command generation subject, either one of the first movement command generator or the second movement command generator; and a transmitter that transmits a movement command generated by the movement command generation subject to the robot controller, and in which the robot controller controls operation of the robot based on the second movement command when receiving the second movement command, and controls operation of the robot to move the control point along the target movement trajectory when receiving the first movement command.

### Effects of the Invention

According to one aspect of the present disclosure, for example, when the robot is made to take charge of the work of machining a workpiece, it is possible to move the control point of the robot along the target movement trajectory calculated by the numerical control device by transmitting the first movement command including the target movement trajectory from the numerical control device to the robot controller, such that it is possible to machine the workpiece with high accuracy by the robot. Furthermore, for example, in a case where work that does not involve machining of a workpiece, specifically, work of conveying a workpiece, is carried out by the robot, it is possible for the robot control device to move the control point of the robot in the shortest time or the shortest route by transmitting a second movement command that does not include the first target movement trajectory from the numerical control device to the robot control device, in consideration of the dynamic characteristics of the robot, such that it is also possible to shorten the machining cycle time of the workpiece by the machine tool and the robot.

### BRIEF DESCRIPTION OF THE DRAWINGS

FIG. 1 is a schematic diagram of a numerical control system according to an embodiment of the present disclosure;

FIG. 2 is a functional block diagram of a numerical control device and a robot control device;

FIG. 3 is a diagram showing an example of a numerical control program for a robot;

FIG. 4A is a sequence diagram (Part 1) showing a flow of signals and information between the numerical control device and the robot control device and a process executed by the robot control device when the numerical control device is operated based on the program shown in FIG. 3; and

FIG. 4B is a sequence diagram (Part 2) showing a flow of signals and information between the numerical control device and the robot control device and a process executed by the robot control device when the numerical control device is operated based on the program shown in FIG. 3.

### PREFERRED MODE FOR CARRYING OUT THE INVENTION

Hereinafter, a numerical control system 1 according to an embodiment of the present disclosure will be described with reference to the drawings.

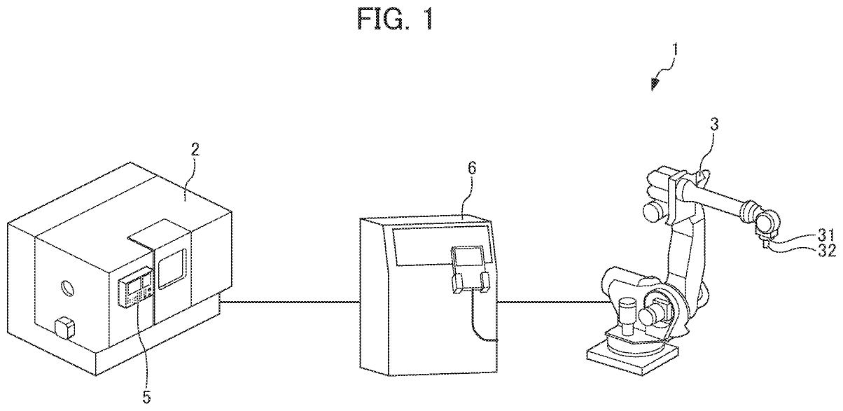

FIG. 1 is a schematic diagram of a numerical control system 1 according to the present embodiment.

The numerical control system 1 includes a machine tool 2, a numerical control device (CNC) 5 for controlling the movement of the machine tool 2, a robot 3 provided in the vicinity of the machine tool 2, and a robot control device 6 communicably connected to the numerical control device 5. The numerical control device 5 controls the movement of the machine tool 2, generates a command to the robot control device 6 for controlling the movement of the robot 3, and transmits the command to the robot control device 6 based on a predetermined numerical control program. The robot control device 6 controls the movement of the robot 3 in accordance with a command transmitted from the numerical control device 5.

The machine tool 2 machines a workpiece (not shown) in accordance with a machine tool control signal transmitted from the numerical control device 5. Here, the machine tool 2 is, for example, a lathe, a ball mill, a milling machine, a grinding machine, a laser processing machine, an injection molding machine, or the like, but is not limited thereto.

The robot 3 moves under the control of the robot control device 6, and performs a predetermined operation on a workpiece machined by the machine tool 2, for example. The robot 3 is, for example, a multi-joint robot, and includes a multifunction tool 32 that is attached to an arm tip portion 31 of the robot 3 and holds and machines a workpiece. Hereinafter, a case where the robot 3 is a six-axis articulated robot will be described, but the present invention is not limited thereto. In the following description, the robot 3 is a six-axis articulated robot, but the number of axes is not limited thereto.

The multifunction tool 32 includes, for example, a plurality of tools such as a deburring tool for removing minute protrusions (so-called burr) remaining on a workpiece machined by the machine tool 2, a cutting tool for cutting the workpiece, and a gripping or holding tool for gripping or holding the workpiece, and any one of such a plurality of tools can be selected as a tool to be used. That is, by selecting a deburring tool as a tool used by the multifunction tool 32, it is possible to perform deburring processing on a workpiece machined by the machine tool 2 by the robot 3. By selecting a cutting tool as a tool used by the multifunction tool 32, cutting can be performed on a workpiece of the machine tool 2 by the robot 3. Furthermore, by selecting a gripping tool as the used tool of the multifunction tool 32, it is possible to perform work of replacing a workpiece of the machine tool 2 by the robot 3.

The numerical control device 5 and the robot control device 6 are each a computer configured by hardware including an arithmetic processing unit such as a CPU (Central Processing Unit), an auxiliary storage unit such as an HDD (Hard Disk Drive) or SSD (Solid State Drive) in which various programs are stored, a main storage unit such as RAM (Random Access Memory) in which data temporarily required for the arithmetic processing unit to execute the programs is stored, an operation means such as a keyboard with which the operator performs various operations, and a display means such as a display for displaying various kinds of information to the operator. The robot control device 6 and the numerical control device 5 can transmit and receive various signals to and from each other by Ethernet (registered trademark), for example.

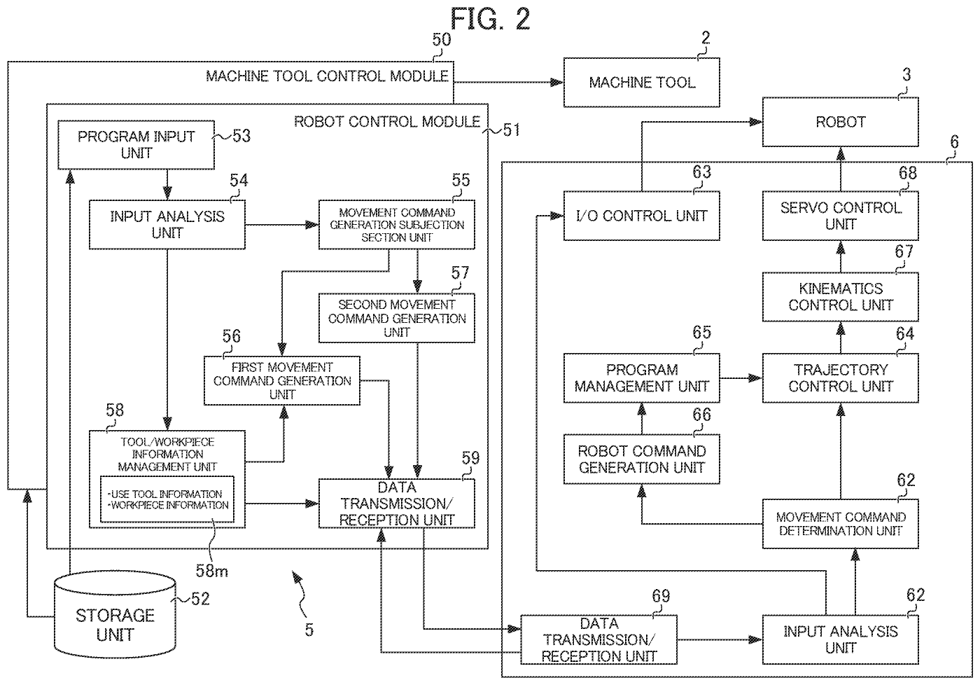

FIG. 2 is a functional block diagram of the numerical control device 5 and the robot control device 6.

The numerical control device 5 generates various commands for controlling the movement of the robot 3 and the changing operation of the tool used in the multifunction tool 32, and transmits the generated robot commands to the robot control device 6 according to the procedure described below. Based on the robot command transmitted from the numerical control device 5, the robot control device 6 generates a robot control signal for controlling the movement of the robot 3 in accordance with the procedure described below, generates an I/O signal for changing the tools used by the multifunction tool 32, and inputs the generated robot control signal and the I/O signal to the robot 3. Thus, the robot control device 6 controls the movement of the robot 3 and the changing operation of the tool used.

First, the detailed configuration of the numerical control device 5 will be described. As shown in FIG. 2, in the numerical control device 5, various functions such as of a machine tool control module 50 serving as a control system of the machine tool 2, a robot control module 51 serving as a control system of the robot 3, and a storage unit 52 are implemented by the hardware configuration.

The storage unit 52 stores, for example, a plurality of numerical control programs created based on operations by an operator. More specifically, the storage unit 52 stores a numerical control program for the machine tool serving as a first numerical control program for controlling the movement of the machine tool 2, a numerical control program for the robot serving as a second numerical control program for controlling the movement of the robot 3 via the robot control device 6, and the like. The numerical control program for the machine tool and the numerical control program for the robot are described in a common programming language (for example, G code, M code, etc.).

The numerical control program for the machine tool is described based on a machine tool coordinate system serving as a first coordinate system whose origin is a reference point determined on the machine tool 2 or in the vicinity of the machine tool 2. That is, in the numerical control program for the machine tool, the position and posture of the control point of the machine tool 2 are described by coordinate values in the machine tool coordinate system.

The numerical control program for the robot is described based on a robot coordinate system as a second coordinate system different from the machine tool coordinate system. That is, in the numerical control program for the robot, the position and posture of the control point of the robot 3 (for example, the arm tip portion 31 of the robot 3) are described by coordinate values in a robot coordinate system different from the machine tool coordinate system. The robot coordinate system is a coordinate system whose origin is a reference point determined on or in the vicinity of the robot 3. In the following description, the robot coordinate system is different from the machine tool coordinate system. However, the present disclosure is not limited thereto. The robot coordinate system may coincide with the machine tool coordinate system. In other words, the origin and the coordinate axis direction of the robot coordinate system may coincide with the origin and the coordinate axis direction of the machine tool coordinate system.

In the numerical control program for the robot, the robot coordinate system can be switched between two or more coordinate formats having different control axes. More specifically, in the numerical control program for the robot, the position and posture of the control point of the robot 3 can be specified by the orthogonal coordinate format or the joint coordinate format.

In the joint coordinate format, the position and posture of the control point of the robot 3 are specified by a total of six real coordinate values including the rotation angle values (J1, J2, J3, J4, J5, J6) of the six joints of the robot 3.

In the orthogonal coordinate format, the position and posture of the control point of the robot 3 are specified by a total of six real coordinate values including three coordinate values (X, Y, Z) along three orthogonal coordinate axes and three rotation angle values (A, B, C) around each orthogonal coordinate axis.

Here, under the joint coordinate format, since the rotation angle of each joint of the robot 3 is directly specified, the axis arrangement of each arm and wrist of the robot 3 and the rotation speed of a joint that can be rotated by 360 degrees or more (hereinafter, these are collectively referred to as “configuration of the robot 3”) are uniquely determined. On the other hand, under the orthogonal coordinate format, since the position and posture of the control point of the robot 3 are designated by the six coordinate values (X, Y, Z, A, B, C), the configuration of the robot 3 cannot be uniquely determined. Therefore, in the numerical control program for the robot, the configuration of the robot 3 can be specified by the configurational value P which is an integer value of a predetermined number of digits. Accordingly, the position and posture of the control point of the robot 3 and the configuration of the robot 3 are represented by six coordinate values (J1, J2, J3, J4, J5, J6) under the joint coordinate format, and six coordinate values and one configurational value (X, Y, Z, A, B, C, P) under the orthogonal coordinate format.

In the numerical control program for the robot, the coordinate format can be set by the G codes “G68.8” and “G68.9”. More specifically, the coordinate format is set to the joint coordinate format by inputting the G code “G68.8”, and the coordinate format is set to the orthogonal coordinate format by inputting the G code “G68.9”. The G codes “G68.8” and “G68.9” for setting these coordinate formats are modal. Accordingly, the coordinate format is maintained until the coordinate format is changed again by the G code after the coordinate format is set to the joint coordinate format or the orthogonal coordinate format by the G code. In the present embodiment, when no G code for setting these coordinate formats is described in the numerical control program for the robot, the coordinate format is automatically set in the orthogonal coordinate format, but the present invention is not limited thereto.

The machine tool control module 50 generates a machine tool control signal for mainly controlling the movement of the machine tool 2 in accordance with a numerical control program for the machine tool, and inputs the machine tool control signal to an actuator (not shown) of the machine tool 2. More specifically, the machine tool control module 50 reads a numerical control program for the machine tool stored in the storage unit 52, and generates a machine tool control signal by analyzing a command type based on the numerical control program. The machine tool 2 moves in response to a machine tool control signal transmitted from the machine tool control module 50, and machines a workpiece (not shown).

The robot control module 51 generates various commands for controlling the movement of the robot 3 and the changing operation of the tool used by the multifunction tool 32 in accordance with a numerical control program for the robot, and transmits the various commands to the robot control device 6. More specifically, the robot control module 51 includes a program input unit 53, an input analysis unit 54, a movement command generation subject selection unit 55, a first movement command generation unit 56, a second movement command generation unit 57, a tool/workpiece information management unit 58, and a data transmission/reception unit 59.

The program input unit 53 reads a numerical control program for the robot from the storage unit 52, and sequentially inputs the numerical control program to the input analysis unit 54.

The input analysis unit 54 analyzes the command type based on the numerical control program for the robot inputted from the program input unit 53 for each command block, and transmits the analysis result to the movement command generation subject selection unit 55 and the tool/workpiece information management unit 58. It is preferable that the input analysis unit 54 first outputs the analysis result of the numerical control program for the robot for a predetermined time. In other words, the input analysis unit 54 preferably transmits the analysis result of the command block executed after a predetermined time period from the present time among the plurality of command blocks constituting the numerical control program for the robot to the movement command generation subject selection unit 55 and the tool/workpiece information management unit 58.

When the type of command acquired based on the numerical control program for the robot is, for example, a command to move the control point of the robot 3, the input analysis unit 54 transmits the acquired command to the movement command generation subject selection unit 55.

Furthermore, when the type of the command acquired based on the numerical control program for the robot is, for example, a command to change the tool used by the multifunction tool 32 mounted on the robot 3, the input analysis unit 54 transmits the acquired command to the tool/workpiece information management unit 58.

When a command is inputted from the input analysis unit 54, the movement command generation subject selection unit 55 selects one of the first movement command generation unit 56 and the second movement command generation unit 57 as a movement command generation subject for generating a movement command for moving the control point of the robot 3. When the first movement command generation unit 56 is selected as the movement command generation subject, the movement command generation subject selection unit 55 transmits the command inputted from the input analysis unit 54 to the first movement command generation unit 56, and when the second movement command generation unit 57 is selected as the movement command generation subject, the movement command generation subject selection unit 55 transmits the command inputted from the input analysis unit 54 to the second movement command generation unit 57.

As shown in FIG. 2, in the numerical control device 5, it is possible for the first movement command generation unit 56 and the second movement command generation unit 57 to generate the movement command for moving the control point of the robot 3. As described later, under the second movement command generated by the first movement command generation unit 56, the movement trajectory from the start point to the end point of the control point of the robot 3 is determined by interpolation processing executed by the first movement command generation unit 56. On the other hand, under the second movement command generated by the second movement command generation unit 57, the movement trajectory of the control point of the robot 3 is determined by the interpolation processing executed by a trajectory control unit 64 (described later) of the robot control device 6. That is, when the first movement command generation unit 56 is selected as the movement command generation subject, the interpolation processing for determining the movement trajectory is executed by the numerical control device 5, and when the second movement command generation unit 57 is selected as the movement command generation subject, the interpolation processing for determining the movement trajectory is executed by the robot control device 6.

In general, high machining accuracy is required for the machine tool; whereas, high versatility is required for the robot, such that the control accuracy of the numerical control device is higher than that of the robot control device. Therefore, in a case where the robot 3 machines a workpiece (e.g., deburring and cutting), in order to machine the workpiece with high accuracy, it is preferable that the movement trajectory of the control point of the robot 3 is accurately determined according to the shape of the tool to be used, the installation position of the workpiece, or the like by the interpolation processing executed by the numerical control device 5. In other words, when the robot 3 machines a workpiece, it is preferable to select the first movement command generation unit 56 as a movement command generation subject.

On the other hand, in a case of performing the workpiece replacement operation by the robot 3, since the control point of the robot 3 needs to be accurately stopped at the end point position, it is preferable that the movement trajectory of the control point of the robot 3 be determined in the shortest time or the shortest path in consideration of the dynamic characteristics of the robot 3 by the interpolation processing executed by the robot control device 6. That is, when the robot 3 does not machine the workpiece, it can be said that it is preferable to select the second movement command generation unit 57 as the movement command generation subject.

In the numerical control program for the robot, the movement command generation subject, i.e., the execution entity of the interpolation processing, can be selected by the G codes “G100.0” and “G100.1”. More specifically, by inputting the G code “G100.0”, the second movement command generation unit 57 is selected as a movement command generation subject. That is, the movement trajectory of the control point is determined by the interpolation processing executed by the robot control device 6. By inputting the G code “G100.1”, the first movement command generation unit 56 is selected as a movement command generation unit. That is, the movement trajectory of the control point is determined by the interpolation processing executed by the numerical control device 5. The G codes “G100.0” and “G100.1” for selecting these movement command generation subjects are modal. Therefore, after the movement command generation subject is set by the G codes, the movement command generation subject is maintained until the movement command generation subject is changed by the G codes.

In the present embodiment, a description will be given of a case where the movement command generation subject selection unit 55 selects, as the movement command generation subject, one designated by the G code in the numerical control program for the robot among the first movement command generation unit 56 and the second movement command generation unit 57. However, the present disclosure is not limited thereto. For example, the movement command generation subject selection unit 55 may determine whether the robot 3 is performing a workpiece machining operation or a workpiece transporting movement based on a numerical control program for the robot, and may select the first movement command generation unit 56 as a movement command generation subject when the robot 3 is performing a workpiece machining operation, and may select the second movement command generation unit 57 as a movement command generation subject when the robot 3 is performing a workpiece transporting movement.

Whether the robot 3 is performing the workpiece machining operation or the workpiece transporting movement can be determined by, for example, the movement command generation subject selection unit 55 depending on the presence or absence of G codes (G40 to G42) for utilizing the tool diameter compensation function described later, G codes (G43, G44, G49) for utilizing the tool length compensation function described later, and G codes (G54.4) for utilizing the work installation error compensation function described later. That is, when various G codes for using the various compensation functions as described above are included in the command inputted from the input analysis unit 54, the movement command generation subject selection unit 55 may determine that the workpiece is being machined, and may select the first movement command generation unit 56 as the movement command generation subject, and when various G codes as described above are not included, the movement command generation subject selection unit 55 may determine that the workpiece is being transported, and may select the second movement command generation unit 57 as the movement command generation subject.

When the second movement command generation unit 57 receives a command from the movement command generation subject selection unit 55, the second movement command generation unit 57 generates a second movement command corresponding to the command, writes the generated second movement command to the data transmission/reception unit 59, and transmits the second movement command to the robot control device 6. Here, the second movement command generated by the second movement command generation unit 57 includes at least information on the position coordinates and the speed of the end point of the control point of the robot 3 designated based on the numerical control program for the robot, but does not include information on a first target movement trajectory described later.

When the first movement command generation unit 56 receives a command from the movement command generation subject selection unit 55, the first movement command generation unit 56 reads the use tool information and workpiece information stored in the memory 58m of the tool/workpiece information management unit 58, generates a first movement command based on the use tool information and workpiece information, and a command inputted from the movement command generation subject selection unit 55, writes the generated second movement command to the data transmission/reception unit 59, and transmits the first movement command to the robot control device 6.

More specifically, the first movement command generation unit 56 performs the interpolation processing based on the command inputted from the movement command generation subject selection unit 55, thereby calculating a first target movement trajectory, which is a target of the movement trajectory from the start point of the control point of the robot 3 to the end point designated based on the numerical control program for the robot, and generates a first movement command including the first target movement trajectory. Unlike the above-described second movement command, the first movement command includes not only the information about the position coordinates of the end point of the control point of the robot 3, but also the information about the coordinate value of the designated position at each designated time, and the acceleration/deceleration at each designated position obtained by time division of the first target movement trajectory.

As described above, in the first movement command generation unit 56, since it is necessary to calculate the first target movement trajectory by performing the interpolation processing, the time required for generation of the movement command is longer than that of the second movement command generation unit 57. In view of this, using the fact that the analysis result of the command block executed after a predetermined time is outputted first from the input analysis unit 54 as described above, it is preferable that the first movement command generation unit 56 generates the first movement command by prefetching or looking ahead the analysis result of the command block executed after a predetermined time from the present time among the plurality of command blocks constituting the numerical control program for the robot. As a result, it is possible to ensure a time for the first movement command generation unit 56 to generate the first movement command.

When the tool/workpiece information management unit 58 receives a command for changing the tool used by the multifunction tool 32 from the input analysis unit 54, the tool/workpiece information management unit 58 generates a tool change command according to the command, writes the generated tool change command to the data transmission/reception unit 59, and transmits the tool change command to the robot control device 6.

Here, the tool/workpiece information management unit 58 includes the memory 58m for storing tool information regarding the shapes of a plurality of tools usable in the multifunction tool 32 mounted on the robot 3, i.e., the shapes of tools which can be appropriately changed by the tool change command (for example, information on tool diameter, tool length, shape of a cutting tool, and the like of each tool), tool specifying information for specifying the tool currently used by the robot 3, and workpiece information regarding the installation position of the workpiece currently installed on the machine tool 2 (for example, information on installation error of a workpiece with respect to a predetermined reference installation position). Among the information stored in the memory 58m, the tool/workpiece information management unit 58 rewrites the tool specifying information and workpiece information appropriately based on a command inputted from the input analysis unit 54, information transmitted from the machine tool control module 50, and the like.

The tool information (the tool diameter, the tool length, the shape of the cutting tool, and the like) and the workpiece information (the installation error of the workpiece) stored in the memory 58m of the tool/workpiece information management unit 58 can be appropriately referred to by the first movement command generation unit 56 when the first movement command generation unit 56 generates the first movement command using the tool diameter compensation function, the tool length compensation function, and the workpiece installation error compensation function.

The tool diameter compensation function is a function whereby the first movement command generation unit 56 calculates a first target movement trajectory of the control point by offsetting the movement path of the control point designated based on the numerical control program for the robot to the right side or the left side within a plane including the movement path by the tool radius. When the G code “G41” is included in the numerical control program for the robot, the first movement command generation unit 56 reads the tool information on the tool designated by a predetermined command together with the G code from the tool/workpiece information management unit 58, and calculates the first target movement trajectory by offsetting the movement path of the control point to the left side by the tool radius. When the G code “G42” is included in the numerical control program for the robot, the first movement command generation unit 56 reads the tool information on the tool designated by a predetermined command together with the G code from the tool/workpiece information management unit 58, and calculates a first target movement trajectory by offsetting the movement path of the control point to the right side by the tool radius. Furthermore, when a command specifying a tool is not included in the numerical control program for the robot, the first movement command generation unit 56 reads from the tool/workpiece information management unit 58 the tool information on the tool specified by the tool specifying information stored in the memory 58m. When the G code “G40” is included in the numerical control program for the robot, the first movement command generation unit 56 cancels the tool diameter compensation function as described above.

The tool length compensation function is a function whereby the first movement command generation unit 56 calculates a first target movement trajectory of the control point by offsetting the movement path of the control point designated based on the numerical control program for the robot to the positive side or the negative side in a direction orthogonal to the plane including the movement path by a predetermined compensation amount corresponding to the tool length. When the G code “G43” is included in the numerical control program for the robot, the first movement command generation unit 56 reads tool information on the tool designated by a predetermined command together with the G code from the tool/workpiece information management unit 58, and calculates a first target movement trajectory by offsetting the movement path of the control point to the positive side by a compensation amount corresponding to the tool length. When the G code “G44” is included in the numerical control program for the robot, the first movement command generation unit 56 reads tool information on the tool designated by a predetermined command together with the G code from the tool/workpiece information management unit 58, and calculates a first target movement trajectory by offsetting the movement path of the control point to the negative side by a compensation amount corresponding to the tool length currently in use. When a command specifying a tool is not included in the numerical control program for the robot, the first movement command generation unit 56 reads from the tool/workpiece information management unit 58 to tool information on the tool specified by the use tool specifying information stored in the memory 58m of the tool/workpiece information management unit 58. When the G code “G49” is included in the numerical control program for the robot, the first movement command generation unit 56 cancels the tool length compensation function as described above.

The workpiece installation error compensation function is a function whereby the first movement command generation unit 56 calculates a first target movement trajectory of the control point by rotating the movement path of the control point designated based on the numerical control program for the robot by an amount corresponding to the workpiece installation error in the three-dimensional space. The first movement command generation unit 56 reads the workpiece information from the tool/workpiece information management unit 58 in a period designated by the G code “G54.4” in the numerical control program for the robot, and calculates a first target movement trajectory by rotating the movement path of the control point in the three-dimensional space by an amount corresponding to the installation error of the current workpiece.

When the second movement command is written by the second movement command generation unit 57, the data transmission/reception unit 59 transmits the second movement command to the data transmission/reception unit 69 of the robot control device 6 at a timing determined based on the numerical control program for the robot. Furthermore, when the first movement command is written by the first movement command generation unit 56, the data transmission/reception unit 59 transmits the first movement command to the data transmission/reception unit 69 at a timing determined based on the numerical control program for the robot. Thus, the data transmission/reception unit 59 transmits the movement command generated by the movement command generation subject to the robot control device 6.

As described above, the first movement command includes the coordinate value of the designated position for each designated time obtained by time division of the first target movement trajectory. Therefore, when the first movement command generation unit 56 is selected as the movement command generation subject, the data transmission/reception unit 59 preferably transmits the first movement command to the robot control device 6 at each designated time.

Furthermore, when the tool/workpiece information management unit 58 writes a tool change command, the data transmission/reception unit 59 transmits the tool change command to the data transmission/reception unit 69 at a timing determined based on the numerical control program for the robot.

Next, a configuration of the robot control device 6 will be described in detail. As shown in FIG. 2, various functions such as an input analysis unit 61, a movement command determination unit 62, an I/O control unit 63, a trajectory control unit 64, a program management unit 65, a robot command generation unit 66, a kinematics control unit 67, a servo control unit 68, and a data transmission/reception unit 69 are implemented in the robot control device 6 by the above hardware configuration.

When receiving commands such as a first movement command, a second movement command, and a tool change command transmitted from the data transmission/reception unit 59 of the numerical control device 5, the data transmission/reception unit 69 sequentially inputs these commands to the input analysis unit 61.

The input analysis unit 61 analyzes a command inputted from the data transmission/reception unit 69, and transmits the analysis result to the movement command determination unit 62 and the I/O control unit 63. More specifically, when the first movement command or the second movement command is inputted from the data transmission/reception unit 69, the input analysis unit 61 transmits the movement command to the movement command determination unit 62. Furthermore, when a tool change command is inputted from the data transmission/reception unit 69, the input analysis unit 61 transmits the tool change command to the I/O control unit 63.

When a tool change command is inputted from the input analysis unit 61, the I/O control unit 63 inputs an I/O signal corresponding to the input tool change command to the multifunction tool 32. Thus, the tool used by the multifunction tool 32 mounted on the robot 3 is changed to the tool designated based on the numerical control program for the robot.

The movement command determination unit 62 determines whether the movement command inputted from the input analysis unit 61 is a first movement command including a first target movement trajectory or a second movement command including no first target movement trajectory. When the first movement command is inputted, the movement command determination unit 62 transmits the first movement command to the trajectory control unit 64. Furthermore, when the second movement command is inputted, the movement command determination unit 62 transmits the second movement command to the robot command generation unit 66.

Upon receiving the second movement command transmitted from the movement command determination unit 62, the robot command generation unit 66 generates a command corresponding to the received second movement command and adds the command to the robot program.

When a new command is added to the robot program, the program management unit 65 sequentially executes the new command to generate a movement plan of the robot 3 corresponding to the second movement command, and transmits the generated movement plan to the trajectory control unit 64.

Upon receiving the movement plan transmitted from the program management unit 65, the trajectory control unit 64 calculates a second target movement trajectory, which is a target of the movement trajectory of the control point of the robot 3, by performing the interpolation processing based on the movement plan, and inputs the second target movement trajectory to the kinematics control unit 67. The kinematics control unit 67 calculates the angles of the joints of the robot 3 as target angles by performing the kinematics calculation based on the second target movement trajectory calculated by the trajectory control unit 64, and transmits these target angles to the servo control unit 68. Furthermore, the servo control unit 68 generates a robot control signal for the robot 3 by feedback-controlling each servo motor of the robot 3 so as to realize a target angle of each joint transmitted from the trajectory control unit 64, and inputs the robot control signal to the servo motor of the robot 3. As described above, when the robot control device 6 receives the second movement command from the numerical control device 5, the robot control device 6 controls the movement of the robot 3 so that the control point of the robot 3 moves along the second target movement trajectory calculated by the interpolation processing executed by the robot control device 6.

When the trajectory control unit 64 receives the first movement command including the coordinate value of the designated position for each designated time obtained by time division of the first target movement trajectory from the movement command determination unit 62 as described above, the trajectory control unit 64 inputs the first movement command to the kinematics control unit 67. Then, the kinematics control unit 67 calculates the target angles of the joints of the robot 3 at each designated time by performing the kinematics calculation based on the first movement command, which is the time series data, and transmits these target angles to the servo control unit 68. Furthermore, the servo control unit 68 generates a robot control signal for the robot 3 by feedback-controlling each servo motor of the robot 3 so as to realize a target angle of each joint transmitted from the trajectory control unit 64, and inputs the robot control signal to the servo motor of the robot 3. As described above, when the robot control device 6 receives the first movement command from the numerical control device 5, the robot control device 6 controls the movement of the robot 3 so that the control point of the robot 3 moves along the first target movement trajectory calculated by the interpolation processing executed by the numerical control device 5.

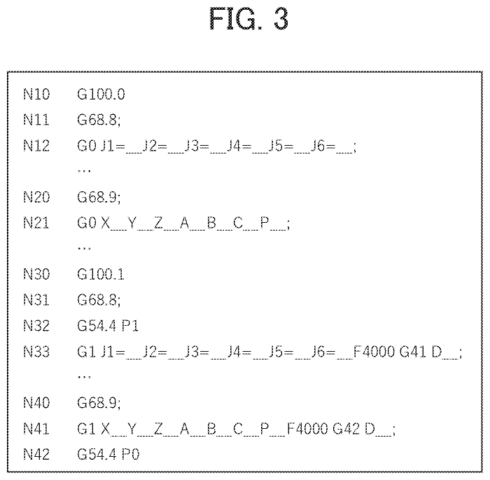

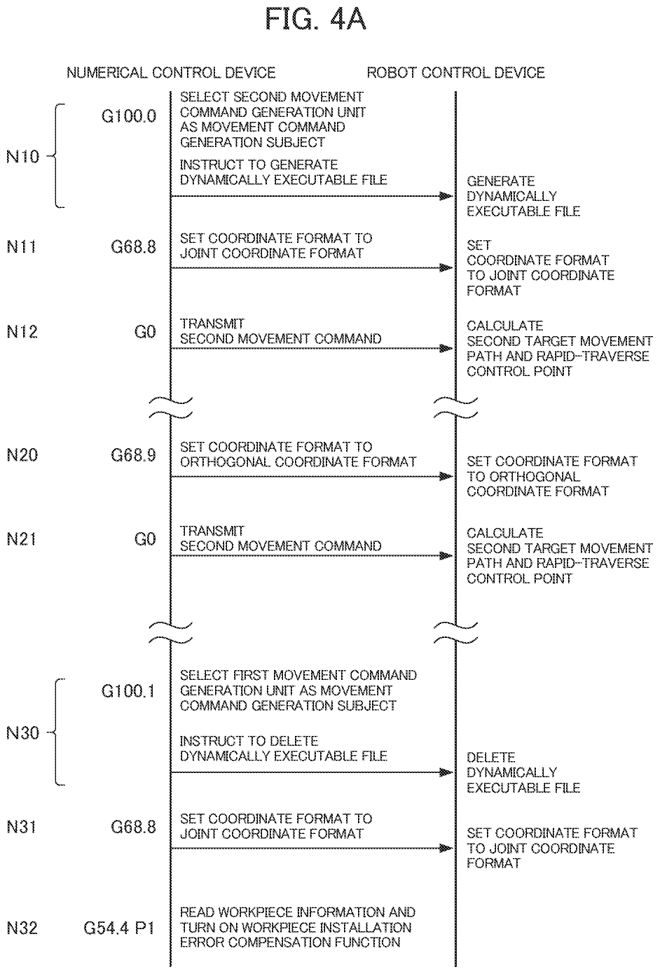

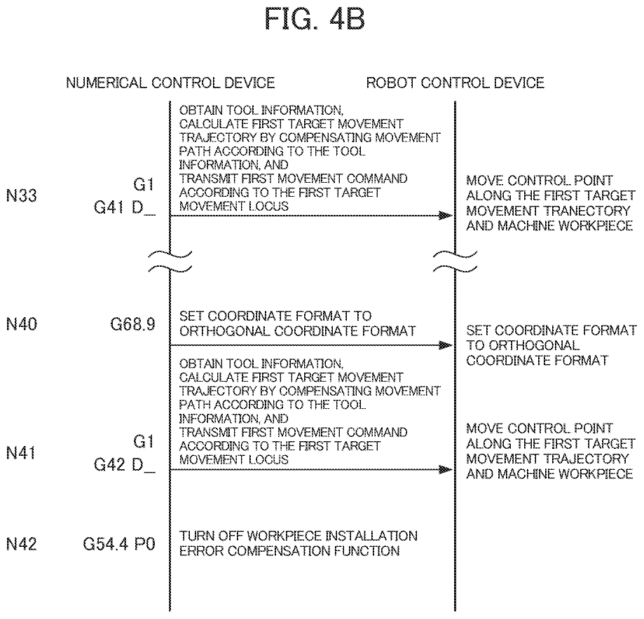

Next, flows of various signals and information in the numerical control system 1 configured as described above will be described with reference to FIGS. 3, 4A and 4B.

FIG. 3 is a diagram showing an example of the numerical control program for the robot. FIGS. 4A and 4B are sequence diagrams showing the flow of signals and information between the numerical control device 5 and the robot control device 6 and the processing executed by the robot control device 6 when the numerical control device 5 is operated based on the numerical control program for the robot illustrated in FIG. 3.

First, in the block indicated by the sequence number “N10”, a command “G100.0” based on G code is inputted to the movement command generation subject selection unit 55 of the numerical control device 5. Thus, the movement command generation subject selection unit 55 selects the second movement command generation unit 57 as the movement command generation subject in order to determine the movement trajectory of the control point of the robot 3 by the interpolation processing executed by the robot control device 6. Furthermore, in response to the input of the command “G100.0”, the movement command generation subject selection unit 55 instructs the robot control device 6 to generate a dynamically executable file for sequentially adding commands to the robot program based on the second movement command transmitted from the numerical value control device 5. In response to this, the robot control device 6 generates this dynamically executable file.

Next, in the block indicated by the sequence number “N11”, a command “G68.8” based on G code is inputted to the input analysis unit 54 of the numerical control device 5. Thus, in the numerical control device 5 and the robot control device 6, the coordinate format is set to the joint coordinate formats.

Next, in the block indicated by the sequence number “N12”, a command “G0 J1=_J2=_J3=_J4=_J5=_J6=_” for causing the control point of the robot 3 to be rapid-traversed to the end point designated based on the joint coordinate format is inputted to the second movement command generation unit 57 of the numerical control device 5. It should be noted that the coordinate value of the end point is inputted to a portion of the underbar in the command. The second movement command generation unit 57 generates a second movement command corresponding to the inputted command and transmits the second movement command to the robot control device 6. The robot control device 6 calculates a second target movement trajectory by performing the interpolation processing based on the second movement command transmitted from the numerical control device 5, and controls the movement of the robot 3 so that the control point of the robot 3 moves along the second target movement trajectory.

Next, in the block indicated by the sequence number “N20”, a command “G68.9” based on G code is inputted to the input analysis unit 54 of the numerical control device 5. Thus, in the numerical control device 5 and the robot control device 6, the coordinate format is set to the orthogonal coordinate format.

Next, in the block indicated by the sequence number “N21”, a command “G0 X_Y_Z_A_B_C_P_” for causing the control point of the robot 3 to be rapid-traversed to the end point designated based on the orthogonal coordinate format is inputted to the second movement command generation unit 57 of the numerical control device 5. The second movement command generation unit 57 generates a second movement command corresponding to the inputted command and transmits the second movement command to the robot control device 6. The robot control device 6 calculates a second target movement trajectory by performing the interpolation processing based on the second movement command transmitted from the numerical control device 5, and controls the movement of the robot 3 so that the control point of the robot 3 moves along the second target movement trajectory.

Next, in the block indicated by the sequence number “N30”, a command “G100.1” based on G code is inputted to the movement command generation subject selection unit 55 of the numerical control device 5. Thus, the movement command generation subject selection unit 55 selects the first movement command generation unit 56 as the movement command generation subject in order to determine the movement trajectory of the control point of the robot 3 by the interpolation processing executed by the numerical control device 5. Furthermore, in response to the input of the command “G100.1”, the movement command generation subject selection unit 55 instructs the robot control device 6 to delete the generated dynamically executable file in order to control the movement of the robot 3 based on the first movement command, which is the time series data transmitted from the numerical control device 5. In response to this, the robot control device 6 deletes the dynamically executable file generated in the block indicated by the sequence number “N10”.

Next, in the block indicated by the sequence number “N31”, a command “G68.8” based on G code is inputted to the input analysis unit 54 of the numerical control device 5. Thus, in the numerical control device 5 and the robot control device 6, the coordinate format is set to the joint coordinate formats.

Next, in the block indicated by the sequence number “N32”, a G code “G54.4P1” for declaring the start of the workpiece installation error compensation function is inputted to the first movement command generation unit 56 of the numerical control device 5. Thus, the first movement command generation unit 56 reads the workpiece information corresponding to the current installation position of the workpiece from the tool/workpiece information management unit 58. Furthermore, the first movement command generation unit 56 calculates the first target movement trajectory by rotating the movement path of the control point in the three-dimensional space by an amount corresponding to the acquired installation error of the workpiece until the G code “G54.4P0” for declaring the end of the workpiece installation error compensation function is inputted in the block indicated by the sequence number “N42” later.

Next, in the block indicated by the sequence number “N33”, a command “G1 J1=_J2=_J3=_J4=_J5=_J6=_F4000 G41 D2” for moving the control point of the robot 3 by linear interpolation at a designated feed speed (F4000) toward the end point designated based on the joint coordinate format is inputted to the first movement command generation unit 56 of the numerical control device 5. The first movement command generation unit 56 calculates a first target movement trajectory in accordance with the inputted command, generates a first movement command, which is time series data including a coordinate value for each designated time along the first target movement trajectory, and transmits the generated first movement command to the robot control device 6. It should be noted that, in the block indicated by “N33”, a G code “G41” for using the tool diameter compensation function and a command “D_” specifying a tool currently in use are inputted. A tool number for specifying a tool currently in use is inputted to a portion indicated by an underbar of the command “D_”. The first movement command generation unit 56 first reads tool information of the tool designated by the tool number from the tool/workpiece information management unit 58. Furthermore, the first movement command generation unit 56 rotates the movement path of the control point calculated based on the numerical value described in the portion indicated by the underbar in the three-dimensional space by an amount corresponding to the installation error of the workpiece acquired in the block indicated by the sequence number “N32”, and calculates a first target movement trajectory of the control point by offsetting the movement path to the left side by an amount corresponding to the tool radius of the tool designated by the tool number, thereby generating a first movement command corresponding to the first target movement trajectory. The robot control device 6 controls the movement of the robot 3 based on the first movement command transmitted from the numerical control device 5, thereby moving the control point of the robot 3 along the first target movement trajectory to machine (for example, cut) the workpiece.

Next, in the block indicated by the sequence number “N40”, a command “G68.9” based on G code is inputted to the input analysis unit 54 of the numerical control device 5. Thus, in the numerical control device 5 and the robot control device 6, the coordinate format is set to the orthogonal coordinate format.

Next, in the block indicated by the sequence number “N41”, a command “G1 X_Y_Z_A_B_C_P_F4000 G42 D” for moving the control point of the robot 3 by linear interpolation at a designated feed speed (F4000) toward the end point designated based on the orthogonal coordinate format is inputted to the second movement command generation unit 57 of the numerical control device 5. The first movement command generation unit 56 calculates a first target movement trajectory according to the inputted command, generates a first movement command, which is time-series data along the first target movement trajectory, and transmits the first movement command to the robot control device 6. It should be noted that, in the block indicated by “N41”, a G code “G42” for using the tool diameter compensation function and a command “D” specifying a tool currently in use are inputted. The first movement command generation unit 56 first reads tool information of the tool designated by the tool number from the tool/workpiece information management unit 58. Furthermore, the first movement command generation unit 56 rotates the movement path of the control point calculated based on the numerical value described in the portion indicated by the underbar in the three-dimensional space by an amount corresponding to the installation error of the workpiece acquired in the block indicated by the sequence number “N32”, and calculates a first target movement trajectory of the control point by offsetting the movement path to the left side by an amount corresponding to the tool radius of the tool designated by the tool number, thereby generating a first movement command corresponding to the first target movement trajectory. The robot control device 6 controls the movement of the robot 3 based on the first movement command transmitted from the numerical control device 5, thereby moving the control point of the robot 3 along the first target movement trajectory to machine (for example, cut) the workpiece.

Next, in the block indicated by the sequence number “N42”, a G code “G54.4P0” for declaring the end of the workpiece installation error compensation function is inputted to the first movement command generation unit 56 of the numerical control device 5. Thus, the first movement command generation unit 56 turns off the workpiece installation error compensation function thereafter.

According to the present embodiment, the following advantageous effects are achieved. In the numerical control system 1, for example, in a case where the robot 3 is responsible for the work of machining the workpiece, it is possible to move the control point of the robot 3 along the first target movement trajectory calculated by the numerical control device 5 by transmitting the first movement command including the first target movement trajectory from the numerical control device 5 to the robot control device 6, such that it is possible to machine the workpiece with high accuracy by the robot 3. Furthermore, for example, in a case where work that does not involve machining of a workpiece, specifically, work of conveying a workpiece, is carried out by the robot 3, it is possible for the robot control device 6 to move the control point of the robot 3 in the shortest time or the shortest route by transmitting a second movement command that does not include the first target movement trajectory from the numerical control device 5 to the robot control device 6, in consideration of the dynamic characteristics of the robot, such that it is also possible to shorten the machining cycle time of the workpiece by the machine tool 2 and the robot 3.

In the numerical control system 1, the first movement command generated by the first movement command generation unit 56 includes the coordinate value of the designated position for each designated time obtained by time division of the first target movement trajectory, and when the first movement command generation unit 56 is selected as the movement command generation subject, the data transmission/reception unit 59 transmits the first movement command to the robot control device 6 at each designated time. According to the numerical control system 1, it is possible for the robot control device 6 to move the control point along the first target movement trajectory without performing the sequential interpolation processing by transmitting the first movement command, which is the time series data, to the robot control device 6.

In the numerical control system 1, the first movement command generation unit 56 generates a first movement command based on tool information and workpiece information stored in the memory 58m of the tool/workpiece information management unit 58. Thus, it is possible for the first movement command generation unit 56 to calculate the first target movement trajectory by compensating the movement trajectory of the control point designated by the numerical control program for the robot in accordance with the shape of the tool used by the robot 3, the installation error of the workpiece, or the like, thereby improving the machining accuracy of the workpiece using the robot 3.

In the numerical control system 1, the movement command generation subject selection unit 55 selects, as the movement command generation subject, one designated based on the numerical control program for the robot among the first movement command generation unit 56 and the second movement command generation unit 57. Thus, it is possible to input the first movement command and the second movement command to the robot control device 6 at a timing determined based on the numerical control program for the robot.

In the numerical control system 1, the movement command generation subject selection unit 55 selects the first movement command generation unit 56 as the movement command generation subject when the robot 3 is performing machining, and selects the second movement command generation unit 57 as the movement command generation subject when the robot 3 is performing transporting. As a result, when the robot 3 is in the machining operation, it is possible to move the control point of the robot 3 along the first target movement trajectory calculated by the numerical control device 5, such that it is possible to machine the workpiece with high accuracy by the robot 3. Furthermore, when the robot 3 is in the transport movement, since it is possible for the robot control device 6 to move the control point of the robot 3 along the second target movement trajectory calculated by considering the dynamic characteristics of the robot 3, it is possible to shorten the cycle time of machining and transporting the workpiece by the machine tool 2 and the robot 3.

In the numerical control system 1, the first movement command generation unit 56 generates a first movement command by looking ahead a command block executed after a predetermined time period from the present time among a plurality of command blocks constituting the numerical control program for the robot. As a result, it is possible to ensure a time for the first movement command generation unit 56 to generate the first movement command. In addition, since it is possible to perform the acceleration/deceleration interpolation in consideration of the preceding position, it is possible to further improve the processing accuracy.

The present disclosure is not limited to the above embodiment, and various changes and modifications are possible.

### EXPLANATION OF REFERENCE NUMERALS

1 . . . numerical control system
2 . . . machine tool
3 . . . robot
32 . . . multifunction tool
5 . . . numerical control device
50 . . . machine tool control module
51 . . . robot control module
55 . . . movement command generation subject selection unit (selector)
56 . . . first movement command generation unit
57 . . . second movement command generation unit
58 . . . tool/workpiece information management unit (storage device)
59 . . . data transmission/reception unit (transmitter)
6 . . . robot control device (robot controller)
62 . . . movement command determination unit
63 . . . I/O control unit
64 . . . trajectory control unit
65 . . . program management unit
66 . . . robot command generation unit
67 . . . kinematics control unit
69 . . . data transmission/reception unit

1. A numerical control device that controls operation of a machine tool and generates operation command for a robot controller that controls operation of a robot to move a control point of the robot based on a numerical control program, the numerical control device comprising:
a first movement command generator that calculates a target movement trajectory, which is a target of a movement trajectory of the control point, and generates a first movement command including the target movement trajectory based on the numerical control program;
a second movement command generator that generates a second movement command which does not include the target movement trajectory based on the numerical control program;
a selector that selects, as a movement command generation subject, either one of the first movement command generator or the second movement command generator; and
a transmitter that transmits a movement command generated by the movement command generation subject to the robot controller.

2. The numerical control device according to claim 1, wherein
the first movement command includes a coordinate value of a designated position for each designated time obtained by time division of the target movement trajectory, and,
when the first movement command generator is selected as the movement command generation subject, the transmitter transmits the first movement command to the robot controller at each of the designated time.

3. The numerical control device according to claim 1, further comprising a storage device that stores at least either tool information on a shape of a tool used by the robot or workpiece information on an installation position of a workpiece to be machined by the machine tool,
wherein the first movement command generator generates the first movement command based on at least either of the tool information or the workpiece information.

4. The numerical control device according to claim 1, wherein the selector selects, as the movement command generation subject, one designated based on the numerical control program among the first movement command generator and the second movement command generator.

5. The numerical control device according to claim 1, wherein the selector selects the first movement command generator as the movement command generation subject when the robot is performing machining, and selects the second movement command generator as the movement command generation subject when the robot is performing transporting.

6. The numerical control device according to claim 1, wherein the first movement command generator generates the first movement command by prefetching a command block executed after a predetermined time period from a present time among a plurality of command blocks constituting the numerical control program.

7. A numerical control system comprising:
a numerical control device that controls operation of a machine tool and generates a movement command for moving a control point of a robot; and
a robot controller that is communicable with the numerical control device and controls operation of the robot based on a movement command transmitted from the numerical control device,
wherein the numerical control device includes:
a first movement command generator that calculates a target movement trajectory, which is a target of a movement trajectory of the control point, and generates a first movement command including the target movement trajectory based on the numerical control program;
a second movement command generator that generates a second movement command which does not include the target movement trajectory based on the numerical control program;
a selector that selects, as a movement command generation subject, either one of the first movement command generator or the second movement command generator; and
a transmitter that transmits a movement command generated by the movement command generation subject to the robot controller, and
wherein the robot controller controls operation of the robot based on the second movement command when receiving the second movement command, and controls operation of the robot to move the control point along the target movement trajectory when receiving the first movement command.
